(19) United States
(12) Patent Application Publication
(10) Pub. No.: US 2026/0021713 A1
(43) Pub. Date: Jan. 22, 2026

(54) JACKRABBIT START SUPPRESSION DEVICE AND VEHICLE

(71) Applicant: SUBARU CORPORATION, Tokyo (JP)

(72) Inventors: Koki MATSUMOTO, Tokyo (JP); Keita NAKAHASHI, Tokyo (JP)

(21) Appl. No.: 19/235,826

(22) Filed: Jun. 12, 2025

(30) Foreign Application Priority Data
Jul. 17, 2024 (JP) 2024-113755

(51) Int. Cl. B60L 15/20

(52) U.S. Cl. CPC B60L 15/2072; B60L 2240/14; B60L 2240/62; B60L 2240/68

(57) ABSTRACT

A jackrabbit start suppression device that suppresses a jackrabbit start of a vehicle is provided. The vehicle includes a drive motor, an accelerator pedal, a simulated clutch pedal, and a simulated shift lever. The jackrabbit start suppression device includes at least one processor and at least one memory. The at least one processor sets a travel mode at next startup of the vehicle to an MT mode, regardless of whether last startup of the vehicle was stopped while the vehicle being in the MT mode, in which a gearshift operation and a clutch operation are enabled, or in an AT mode, in which the gearshift and clutch operations are disabled. The at least one processor prohibits startup of the vehicle when the driver performs a startup operation of the vehicle while a depression of the simulated clutch pedal is less than or equal to a prescribed value.

### CROSS-REFERENCE TO RELATED APPLICATIONS

The present application claims priority from Japanese Patent Application No. 2024-113755 filed on Jul. 17, 2024, the entire contents of which are hereby incorporated by reference.

### BACKGROUND

The present disclosure relates to a jackrabbit start suppression device and a vehicle.

In recent years, vehicles are increasingly being electrified to comply with stricter exhaust emission regulations, and the market is shrinking for vehicles (hereinafter abbreviated as “MT vehicles”) equipped with a manual transmission that switches gear ratios according to manual operations by the driver. However, a certain amount of demand for MT vehicles also exists, and a technology is known in which driver operations with respect to a shifter device and a clutch device in an MT vehicle are reproduced in a simulated manner in an electric vehicle driven by a motor.

For example, Japanese Unexamined Patent Application Publication (JP-A) No. 2023-179360 discloses an electric vehicle provided with a rotary machine that transmits torque to wheels, a vehicle interior component provided to a vehicle seat or a vehicle door, a control unit that controls the rotary machine, and a component control unit that controls the vehicle interior component. The electric vehicle is not provided with any of an engine or a transmission and a clutch mechanism coupled to the engine. The control unit includes a mode switching unit that switches modes between a manual mode, in which the rotary machine is controlled to simulate a manual transmission in response to operations by an occupant, and a normal mode, in which the rotary machine is controlled differently from the manual mode. The component control unit controls the vehicle interior component when the mode is switched to the manual mode by the mode switching unit.

JP-A No. 2022-044955 discloses an electric vehicle that uses an electric motor as a motive power device for travel. The electric vehicle is provided with an accelerator pedal, a simulated clutch pedal, a simulated shifter device, a mode select switch for selecting a control mode of the electric motor between a first mode and a second mode, and a control device that controls motor torque outputted by the electric motor in accordance with the control mode selected by the mode select switch. The control device includes a memory and a processor. The memory stores: an MT vehicle model simulating the torque characteristics of drive wheel torque in an MT vehicle with an internal combustion engine whose torque is controlled by operation of a gas pedal and a manual transmission whose gear stages are switched by operation of a clutch pedal and operation of a shifter device; and a motor torque command map defining the relationship of the motor torque with respect to the displacement of the accelerator pedal and the rotation rate of the electric motor. When controlling the electric motor in the first mode, the processor executes: processing to accept a displacement of the accelerator pedal as the input of a displacement of the gas pedal into the MT vehicle model; processing to accept a displacement of the simulated clutch pedal as the input of a displacement of the clutch pedal into the MT vehicle model; processing to accept a shift position of the simulated shifter device as the input of the shifter device into the MT vehicle model; processing to calculate the drive wheel torque using the MT vehicle model, the drive wheel torque being determined by the displacement of the accelerator pedal, the displacement of the simulated clutch pedal, and the shift position of the simulated shifter device; and processing to compute the motor torque for providing the drive wheel torque to drive wheels of the vehicle. When controlling the electric motor in the second mode, the processor executes: processing to disable operation of the simulated clutch pedal and the simulated shifter device; and processing to compute the motor torque using the motor torque command map on the basis of the displacement of the accelerator pedal and the rotation rate of the electric motor. When the first mode is selected by the mode select switch, the electric motor is controlled so as to obtain the motor torque in the second mode if either one of the following holds true: the gear stage of the MT vehicle model as determined by the shift position is less than a prescribed value; or the vehicle speed of the vehicle is less than a prescribed value.

JP-A No. 2022-042730 discloses an electric vehicle that uses an electric motor as a motive power device for travel. The electric vehicle is provided with an accelerator pedal, a simulated clutch pedal, a simulated shifter device, a simulated engine rotation rate meter, and a control device that controls motor torque outputted by the electric motor. The control device includes a memory and a processor. The memory stores an MT vehicle model simulating the torque characteristics of drive wheel torque in an MT vehicle with an internal combustion engine whose torque is controlled by operation of a gas pedal and a manual transmission whose gear stages are switched by operation of a clutch pedal and operation of a shifter device. The processor executes: processing to accept a displacement of the accelerator pedal as the input of a displacement of the gas pedal into the MT vehicle model; processing to accept a displacement of the simulated clutch pedal as the input of a displacement of the clutch pedal into the MT vehicle model; processing to accept a shift position of the simulated shifter device as the input of a shift position of the shifter device into the MT vehicle model; processing to calculate the drive wheel torque using the MT vehicle model, the drive wheel torque being determined by the displacement of the accelerator pedal, the displacement of the simulated clutch pedal, and the shift position of the simulated shifter device; processing to compute the motor torque for providing the drive wheel torque to drive wheels of the electric vehicle; and processing to display on the simulated engine rotation rate meter a rotation rate of the internal combustion engine calculated using the MT vehicle model. When a zero start acceleration operation to couple the simulated clutch pedal is detected when the electric vehicle is stopped and the rotation rate of the internal combustion engine displayed on the simulated engine rotation rate meter has increased to near a prescribed rotation rate, at least one of the following processing is executed: processing to increase the torque of the electric motor beyond the torque for a normal start; and processing to increase a torque transmission gain, which is determined by the displacement of the simulated clutch pedal, beyond the torque transmission gain for a normal start.

### SUMMARY

An aspect of the disclosure provides a jackrabbit start suppression device configured to suppress a jackrabbit start of a vehicle. The vehicle includes a drive motor, an accelerator pedal, a simulated clutch pedal, and a simulated shift lever. The accelerator pedal is configured to accept an acceleration demand by a driver who drives a vehicle. The simulated clutch pedal is configured to be operated by the driver and to simulate a clutch operation. The simulated shift lever is configured to be operated by the driver and to simulate a gearshift operation. The jackrabbit start suppression device includes at least one processor and at least one memory. The at least one memory is communicatively connected to the at least one processor. The at least one processor is configured to set a travel mode at next startup of the vehicle to an manual transmission mode, regardless of whether last startup of the vehicle was stopped while the vehicle being in the manual transmission mode, in which a gearshift operation and a clutch operation are enabled, or in an automatic transmission mode, in which the gearshift operation and the clutch operation are disabled. The at least one processor is configured to prohibit startup of the vehicle when the driver performs a startup operation of the vehicle while a depression of the simulated clutch pedal is less than or equal to a prescribed value.

An aspect of the disclosure provides a vehicle. The vehicle includes a drive motor, an accelerator pedal, a simulated clutch pedal, a simulated shift lever, and the jackrabbit start suppression device according to the above aspect. The accelerator pedal is configured to accept an acceleration demand by a driver who drives a vehicle. The simulated clutch pedal is configured to be operated by the driver and to simulate a clutch operation. The simulated shift lever is configured to be operated by the driver and to simulate a gearshift operation.

### BRIEF DESCRIPTION OF THE DRAWINGS

The accompanying drawings are included to provide a further understanding of the disclosure and are incorporated in and constitute a part of this specification. The drawings illustrate an embodiment and, together with the specification, serve to describe the principles of the disclosure.

FIG. 1 is a schematic diagram illustrating an example of the configuration of a vehicle provided with a jackrabbit start suppression device according to an embodiment of the disclosure;

FIG. 2 is a block diagram illustrating an example of the configuration of a jackrabbit start suppression device according to the embodiment of the disclosure;

FIG. 3 is a flowchart for describing a first example of operations by a jackrabbit start suppression device according to the embodiment of the disclosure; and

FIG. 4 is a flowchart for describing a second example of operations by a jackrabbit start suppression device according to the embodiment of the disclosure.

### DETAILED DESCRIPTION

According to the technologies described in JP-A No. 2023-179360, JP-A No. 2022-044955, and JP-A No. 2022-042730, an electric vehicle provided with both an automatic transmission (AT) mode and a manual transmission (MT) mode as travel modes can be achieved. In AT mode, the driver can achieve quick acceleration by depressing the accelerator pedal. On the other hand, in MT mode, the driver can feel as though they are driving a normal MT vehicle, even in an electric vehicle. However, there is a problem in that, since AT mode has fewer operations and confirmations at starting of the vehicle than MT mode, jackrabbit starts that do not conform to driver intentions occur more readily in AT mode than in MT mode.

In light of such circumstances, it is desirable to provide a technology for suppressing jackrabbit starts that do not conform to driver intentions in an electric vehicle in which driver operations for a vehicle provided with a manual transmission are reproduced in a simulated manner.

Hereinafter, an embodiment of the present disclosure will be described in detail and with reference to the attached drawings. Note that, in this specification and the drawings, component elements that have substantially the same function and/or configuration are denoted with the same reference signs to omit duplicate description.

### 1. Overall Configuration of Vehicle

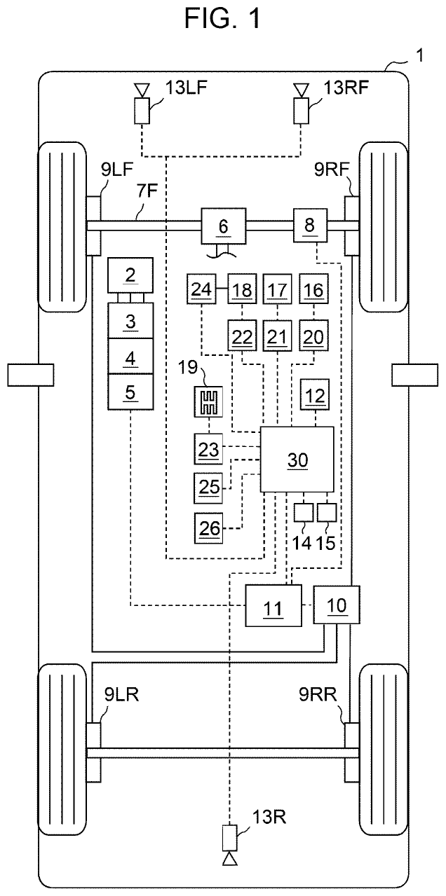

The following refers to FIG. 1 to describe an example of the overall configuration of a vehicle 1 provided with a jackrabbit start suppression device 30 according to the embodiment of the present disclosure.

The vehicle 1 is configured as a four-wheeled automobile with front-wheel drive in which drive torque outputted from a drive motor 2, which is described in detail later, is transmitted to left and right front wheels. Note that the drive wheel combination and the driving method are not limited to the above. For example, the vehicle 1 may be a rear-wheel drive vehicle, a four-wheel drive vehicle, or a vehicle with drive motors provided in a one-to-one correspondence with the wheels.

The vehicle 1 is provided with a drive motor 2, an inverter 3, a converter 4, and a drive battery 5.

The drive motor 2 outputs drive torque to be transmitted to the front wheels via a differential mechanism 6 and a front wheel drive shaft 7F. The drive motor 2 may be configured as a three-phase alternating-current (AC) motor. In this case, three-phase AC currents are supplied to a stator (not illustrated) to form a rotating magnetic field that causes a rotor (not illustrated) to rotate, thereby outputting drive torque. The drive motor 2 has a function of performing regenerative power generation by having the rotor rotate in response to rotational torque of the front wheels transmitted via the front wheel drive shaft 7F in a state in which three-phase AC currents are not being supplied to the stator. The driving of the drive motor 2 is controlled by a vehicle control device 11, the details of which will be described later.

The inverter 3 is provided with an inverter circuit that converts swept direct-current (DC) power from the drive battery 5 into three-phase AC power and supplies the three-phase AC power to the stator of the drive motor 2. The inverter circuit converts three-phase AC power regeneratively generated by the stator of the drive motor 2 into DC power and supplies the DC power to the converter 4. The driving of the inverter 3 is controlled by the vehicle control device 11.

The converter 4 is provided with a boost circuit that boosts the voltage of the power regeneratively generated by the drive motor 2 to a designated charging voltage of the drive battery 5 and supplies the voltage-boosted power to the drive battery 5. Note that the boost circuit may have a function of boosting or bucking the output voltage of the drive battery 5 to supply power to the inverter 3. The driving of the converter 4 is controlled by the vehicle control device 11.

The drive battery 5 supplies power to the drive motor 2. The drive battery 5 may be, for example, a secondary battery configured to be chargeable and dischargeable, such as a lithium-ion battery or an all-solid-state battery with a rated voltage of approximately 200 V to 800 V, but the present disclosure is not limited to the above.

The vehicle 1 is further provided with a power steering device 8, brake devices 9LF, 9RF, 9LR, and 9RR (hereinafter abbreviated as the “brake devices 9” when not being distinguished individually), and the vehicle control device 11.

The power steering device 8 is provided on the front wheel drive shaft 7F. The power steering device 8 includes an electric motor (not illustrated) and a gear mechanism (not illustrated), and is controlled by the vehicle control device 11 to adjust the steering angle of the front wheels. Note that the vehicle control device 11 controls the power steering device 8 on the basis of the steering angle of a steering wheel (not illustrated) manipulated by the driver. In the case where the vehicle 1 is a vehicle capable of executing self-driving control, during manual driving, the vehicle control device 11 controls the power steering device 8 on the basis of the steering angle of the steering wheel manipulated by the driver. On the other hand, during self-driving, the vehicle control device 11 controls the power steering device 8 on the basis of a steering angle or a steering angular velocity set by a known or chosen method.

The brake devices 9LF, 9RF, 9LR, and 9RR each apply a braking force to a corresponding wheel. The brake devices 9 may be hydraulic brake devices, for example. In this case, the hydraulic pressure supplied to each of the brake devices 9 is adjusted by having the vehicle control device 11 control the driving of a fluid pressure unit 10. Note that the brake devices 9 may be used in conjunction with regenerative braking by the drive motor 2.

The vehicle control device 11 mainly includes at least one electronic control unit (ECU) that controls the driving of the drive motor 2, the power steering device 8, and the fluid pressure unit 10.

The vehicle 1 is further provided with a notification device 12. The notification device 12 is driven by the jackrabbit start suppression device 30 and notifies the driver of various kinds of information by sound or voice output and/or text or image display. The notification device 12 may include a display, a speaker, and the like provided to an instrument panel, for example. Note that the notification device 12 may also include a head-up display (HUD) that presents a display on the front window of the vehicle 1.

The vehicle 1 is further provided with a surrounding environment sensor 13, a vehicle state sensor 14, and a global navigation satellite system (GNSS) sensor 15.

The surrounding environment sensor 13 includes front-facing cameras 13LF and 13RF and a rear-facing camera 13R, for example. The front-facing cameras 13LF and 13RF perform image capture in front of the vehicle 1 and generate image data. The rear-facing camera 13R performs image capture behind the vehicle 1 and generates image data. The front-facing cameras 13LF and 13RF and the rear-facing camera 13R are each provided with an image sensor such as a charge-coupled device (CCD) sensor or a complementary metal-oxide-semiconductor (CMOS) sensor, and transmit generated image data to the jackrabbit start suppression device 30. In the vehicle 1 illustrated in FIG. 1, the front-facing cameras 13LF and 13RF are configured as a stereo camera including a pair of left and right cameras, but the front-facing cameras 13LF and 13RF may be a monocular camera. Otherwise, the surrounding environment sensor 13 may include at least one range sensor from among any of a radar sensor, such as a light detection and ranging (LiDAR) sensor or a millimeter-wave radar, and an ultrasonic sensor.

The vehicle state sensor 14 includes at least one sensor that detects the state of the vehicle 1. The vehicle state sensor 14 includes, for example, a vehicle speed sensor that detects the vehicle speed of the vehicle 1. Note that the vehicle state sensor 14 may also include an acceleration sensor, an angular velocity sensor, or the like besides a vehicle speed sensor. A detection signal from the vehicle state sensor 14 is transmitted to the jackrabbit start suppression device 30.

The GNSS sensor 15 receives satellite signals from positioning satellites, such as Global Positioning System (GPS) satellites. The GNSS sensor 15 transmits position information about the vehicle 1 included in the received satellite signals to the jackrabbit start suppression device 30. Note that, besides a GPS sensor, the GNSS sensor 15 may also be provided with an antenna for receiving satellite signals from another satellite system for identifying the position of the vehicle 1.

The vehicle 1 is further provided with an accelerator pedal 16, a brake pedal 17, a simulated clutch pedal 18, and a simulated shift lever 19.

The accelerator pedal 16 accepts an acceleration demand by the driver. The accelerator pedal 16 is provided with an accelerator pedal sensor 20 that detects the depression of the accelerator pedal 16 by the driver. A detection signal from the accelerator pedal sensor 20 is transmitted to the jackrabbit start suppression device 30.

The brake pedal 17 accepts a braking demand by the driver. The brake pedal 17 is provided with a brake pedal sensor 21 that detects the depression of the brake pedal 17 by the driver. A detection signal from the brake pedal sensor 21 is transmitted to the jackrabbit start suppression device 30.

The simulated clutch pedal 18 and the simulated shift lever 19 accept a simulated gearshift demand by the driver. However, the vehicle 1 is an electric vehicle driven by the drive motor 2, and is not provided with an internal combustion engine such as a gasoline engine or a diesel engine as a source of driving power. Therefore, the vehicle 1 is not provided with a clutch mechanism or a transmission mechanism provided in a normal MT vehicle.

The simulated clutch pedal 18 is configured to be operated by the driver and allows for simulated clutch operations. In other words, the simulated clutch pedal 18 has a structure resembling a clutch pedal provided in a normal MT vehicle. The placement of the simulated clutch pedal 18 is similar to that of a normal MT vehicle. The simulated clutch pedal 18 is depressed in cases such as when the driver operates the simulated shift lever 19. The simulated clutch pedal 18 is provided with a simulated clutch pedal sensor 22 that detects the depression of the simulated clutch pedal 18 by the driver. A reaction force actuator 24 may be coupled to the simulated clutch pedal 18, the reaction force actuator 24 being driven by the jackrabbit start suppression device 30 to generate a pedal reaction force that acts to cancel out the force of depressing the simulated clutch pedal 18 by the driver. Note that the structure of the reaction force actuator 24 is not particularly limited, and a known structure may be adopted. A detection signal from the simulated clutch pedal sensor 22 is transmitted to the jackrabbit start suppression device 30.

The simulated shift lever 19 is configured to be operated by the driver and allows for simulated gearshift operations. In other words, the simulated shift lever 19 has a structure resembling a shift lever having what is called an H-pattern or the like provided in a normal MT vehicle. The placement and feel of the simulated shift lever 19 are similar to that of a normal MT vehicle. The simulated shift lever 19 is operated manually by the driver when the driver inputs a simulated gearshift demand to the vehicle 1. The simulated shift lever 19 is provided with a simulated shift lever sensor 23 that detects the shift position of the simulated shift lever 19. A detection signal from the simulated shift lever sensor 23 is transmitted to the jackrabbit start suppression device 30.

Besides the simulated shift lever 19 operated by the driver during MT mode, the vehicle 1 is further provided with a shift switch 25 configured to be operated by the driver during AT mode. The shift positions of the shift switch 25 include P (parking), R (reverse), N (neutral), D (drive), and the like. Note that although the shift switch 25 may be preferable from the standpoint of facilitating blind operation by the driver, a shift lever similar to that of a normal AT vehicle may be employed instead. From a similar standpoint, during AT mode, the simulated shift lever 19 may be stowed internally in the vehicle under control by an ECU or the like. Meanwhile, during MT mode, the shift switch 25 may be stowed internally in the vehicle under control by an ECU or the like, or a position lamp indicating the shift position of the shift switch 25 may be turned off.

Note that in the case where the vehicle 1 is provided with an electric parking brake, the electric parking brake may be usable in both AT mode and MT mode. In the case where the vehicle 1 is not provided with an electric parking brake, only “P” of the shift switch 25 may be usable while the vehicle 1 being in MT mode.

Otherwise, the vehicle 1 may be further provided with a car body vibration generator device 26. The car body vibration generator device 26 is driven by the jackrabbit start suppression device 30 and is capable of generating car body vibration resembling that of a normal MT vehicle when the simulated clutch pedal 18 or the simulated shift lever 19 is operated by the driver. This allows the feel of the simulated clutch pedal 18 or the simulated shift lever 19 to approach the feel in a normal MT vehicle. The car body vibration generator device 26 may be mounted on a suspension (not illustrated) provided to the vehicle 1, for example. Note that the structure of the car body vibration generator device 26 is not particularly limited, and, for example, an electric cylinder, a hydraulic cylinder, or a gas cylinder may be adopted.

### 2. Jackrabbit Start Suppression Device

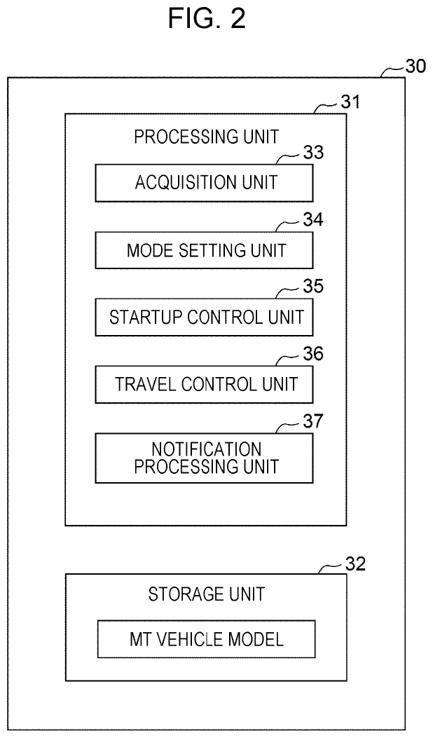

The following refers to FIG. 2 to describe the jackrabbit start suppression device 30 according to the present embodiment.

### 2-1. Example of Configuration

The jackrabbit start suppression device 30 functions as a device that suppresses jackrabbit starts by the vehicle 1 as a result of at least one processor, such as a central processing unit (CPU), executing a computer program. The computer program causes the processor to execute operations, described later, to be executed by the jackrabbit start suppression device 30. The computer program to be executed by the processor may be recorded on a recording medium that functions as a storage unit (memory) 32 described later, or may be recorded on a recording medium of any kind that is built into the jackrabbit start suppression device 30 or externally attachable to the jackrabbit start suppression device 30.

The recording medium used to record the computer program may be: a magnetic medium such as a hard disk, a floppy disk, or magnetic tape; an optical recording medium such as CD-ROM, DVD, or Blu-ray® Disc; a magneto-optical medium such as a floptical disk; a memory element such as RAM or ROM; flash memory such as USB memory or an SSD; or some other medium capable of storing a program.

To the jackrabbit start suppression device 30, the vehicle control device 11, the notification device 12, the surrounding environment sensor 13, the vehicle state sensor 14, and the GNSS sensor 15 are connected via communication carried over dedicated lines, a controller area network (CAN), a local interconnect network (LIN), or the like. Also, to the jackrabbit start suppression device 30, the accelerator pedal 16 and the accelerator pedal sensor 20, the brake pedal 17 and the brake pedal sensor 21, the simulated clutch pedal 18 and the simulated clutch pedal sensor 22, the reaction force actuator 24, the simulated shift lever 19 and the simulated shift lever sensor 23, the shift switch 25, and the car body vibration generator device 26 are connected via communication carried over dedicated lines, a CAN, an LIN, or the like. Note that some or all of the configuration of the jackrabbit start suppression device 30 may be provided in the vehicle control device 11.

The jackrabbit start suppression device 30 is provided with a processing unit 31 and a storage unit 32.

### Processing Unit

The processing unit 31 is provided with at least one processor, such as a CPU, and various peripheral components. Some or all of the processing unit 31 may be configured to have updatable firmware or the like, or may be a program module or the like executed according to an instruction from the CPU or the like.

### Storage Unit

The storage unit 32 is formed from at least one memory element, such as RAM or ROM, communicatively connected to the processing unit 31. However, the storage unit 32 is not particularly limited in type or in number. The storage unit 32 stores a computer program to be executed by the processing unit 31, various parameters to be used in computational processing, and information such as detection data and computational results. Note that an MT vehicle model simulating a normal MT vehicle, described later, is stored in advance in the storage unit 32.

### 2-2. Functional Configuration of Processing Unit

The following describes a functional configuration of the processing unit 31 of the jackrabbit start suppression device 30. The processing unit 31 is provided with an acquisition unit 33, a mode setting unit 34, a startup control unit 35, a travel control unit 36, and a notification processing unit 37. These units are functions achieved by the execution of a computer program by at least one processor, such as a CPU. However, some or all of the acquisition unit 33, the mode setting unit 34, the startup control unit 35, the travel control unit 36, and the notification processing unit 37 may be configured using analog circuitry.

### Acquisition Unit

The acquisition unit 33 acquires the depression of the accelerator pedal 16 by the driver on the basis of a detection signal from the accelerator pedal sensor 20. The acquisition unit 33 also acquires the depression of the brake pedal 17 by the driver on the basis of a detection signal from the brake pedal sensor 21. The acquisition unit 33 also acquires the depression of the simulated clutch pedal 18 by the driver on the basis of a detection signal from the simulated clutch pedal sensor 22. The acquisition unit 33 also acquires the shift position of the simulated shift lever 19 on the basis of a detection signal from the simulated shift lever sensor 23. Note that the various kinds of information acquired by the acquisition unit 33 may be stored in the storage unit 32.

The acquisition unit 33 also acquires a vehicle 1 startup request from the driver. Specifically, when the vehicle 1 is in a non-operational state, the acquisition unit 33 acquires a control signal via the vehicle control device 11, for example, the control signal indicating that a start switch (not illustrated) has been switched on by the driver. The acquisition unit 33 also detects a vehicle 1 shutdown request from the driver. Specifically, when the vehicle 1 is in an operational state, the acquisition unit 33 acquires a control signal via the vehicle control device 11, for example, the control signal indicating that the start switch has been switched off by the driver. Note that the operational state means a state in which the vehicle 1 is capable of travel in response to driving operations by the driver, while the non-operational state means a state in which the vehicle 1 does not accept driving operations by the driver.

### Mode Setting Unit

The mode setting unit 34 controls the travel modes of the vehicle 1 on the basis of an input operation performed by the driver with respect to a toggle switch (not illustrated) provided in the vehicle 1. The travel modes include MT mode in which gearshift operations and clutch operations are enabled, and AT mode in which gearshift operations and clutch operations are disabled. Also, regardless of whether the last startup of the vehicle 1 was stopped while the vehicle 1 being in MT mode or AT mode, the mode setting unit 34 sets the travel mode at next startup of the vehicle 1 to MT mode.

Consequently, the travel mode is always set to MT mode at startup of the vehicle 1. While the vehicle 1 is in the operational state, the mode setting unit 34 can switch between AT mode and MT mode on the basis of an input operation by the driver. Also, if the vehicle 1 once transitions from the operational state to the non-operational state, the mode setting unit 34 forces the initial travel mode at next startup of the vehicle 1 to MT mode.

### Startup Control Unit

As described above, regardless of whether the last startup of the vehicle 1 was stopped while the vehicle 1 being in MT mode or AT mode, the initial travel mode at next startup of the vehicle 1 is always set to MT mode. At startup of the vehicle 1, the startup control unit 35 carries out the following control.

The startup control unit 35 permits startup of the vehicle 1 if the driver performs a vehicle 1 startup operation while the depression of the simulated clutch pedal 18 exceeds a prescribed value. Specifically, if the vehicle 1 is in the non-operational state and the startup control unit 35 acquires, via the acquisition unit 33, a startup request from the driver and an indication that the depression of the simulated clutch pedal 18 exceeds the prescribed value, the startup control unit 35 causes the vehicle 1 to transition from the non-operational state to the operational state. This allows the vehicle 1 to travel under control by the travel control unit 36 described later. Note that the prescribed value is set within, for example, the range from 80% to 100% of the depression when the simulated clutch pedal 18 is fully depressed, but the present disclosure is not limited thereto, and the prescribed value may be set appropriately.

On the other hand, the startup control unit 35 prohibits startup of the vehicle 1 if the driver performs the vehicle 1 startup operation while the depression of the simulated clutch pedal 18 is less than or equal to the prescribed value. Specifically, if the vehicle 1 is in the non-operational state and the startup control unit 35 acquires, via the acquisition unit 33, a startup request from the driver and an indication that the depression of the simulated clutch pedal 18 is less than or equal to the prescribed value, the startup control unit 35 causes the vehicle 1 to stay in the non-operational state.

### Travel Control Unit: AT Mode

The travel control unit 36 carries out the following control when startup of the vehicle 1 is permitted by the startup control unit 35 and AT mode is selected as the travel mode.

The travel control unit 36 derives a drive torque determined by the depression of the accelerator pedal 16. The travel control unit 36 also derives, from the derived drive torque, a motor torque to be applied to the drive wheels of the vehicle 1. The travel control unit 36 also transmits a control signal based on the derived motor torque to the inverter 3 via the vehicle control device 11. However, the output characteristics of the drive motor 2 are determined appropriately according to the shift position of the shift switch 25. Note that the inverter 3 controls the drive torque of the drive motor 2 on the basis of the control signal received from the vehicle control device 11.

### Travel Control Unit: MT Mode

The travel control unit 36 carries out the following control when startup of the vehicle 1 is permitted by the startup control unit 35 and MT mode is selected as the travel mode.

The travel control unit 36 accepts the depression of the accelerator pedal 16 by the driver as the depression of an accelerator pedal for controlling fuel supply to an internal combustion engine in a normal MT vehicle. The travel control unit 36 also accepts the depression of the simulated clutch pedal 18 by the driver as the depression of a clutch pedal for operating a clutch in a normal MT vehicle. The travel control unit 36 also accepts operation of the simulated shift lever 19 by the driver as an operation of a shift lever for switching gear stages in a normal MT vehicle. The travel control unit 36 also uses an MT vehicle model simulating a normal MT vehicle to derive a drive torque determined by the depression of the accelerator pedal 16, the depression of the simulated clutch pedal 18, and the shift position of the simulated shift lever 19. The MT vehicle model in this case may be a known model disclosed in JP-A No. 2024-043344 or elsewhere, and may be stored in advance in the storage unit 32 as described above. The travel control unit 36 also derives, from the derived drive torque, a motor torque to be applied to the drive wheels of the vehicle 1. The travel control unit 36 also transmits a control signal based on the derived motor torque to the inverter 3 via the vehicle control device 11. Note that the inverter 3 controls the drive torque of the drive motor 2 on the basis of the control signal received from the vehicle control device 11.

With this arrangement, when changing the shift position or starting the vehicle 1, for example, the driver can change gear stages by operating the simulated shift lever 19 and adjust the vehicle speed by operating the accelerator pedal 16 in addition to operating the simulated clutch pedal 18, and thus experience a drive feel similar to that of a normal MT vehicle. Note that, upon detecting via the acquisition unit 33 that the driver has performed an inappropriate operation of the simulated clutch pedal 18 or the simulated shift lever 19, the travel control unit 36 can also reproduce an engine stall condition in a simulated manner by carrying out control to stop the output of the drive motor 2 on the basis of the MT vehicle model.

### Notification Processing Unit

The notification processing unit 37 controls the driving of the notification device 12 to execute a process for notifying the driver that the vehicle 1 was not started up properly or the like. Note that this process may be executed via sound or speech output, via image display, or via text display.

### 2-3. First Example of Operations by Jackrabbit Start Suppression Device

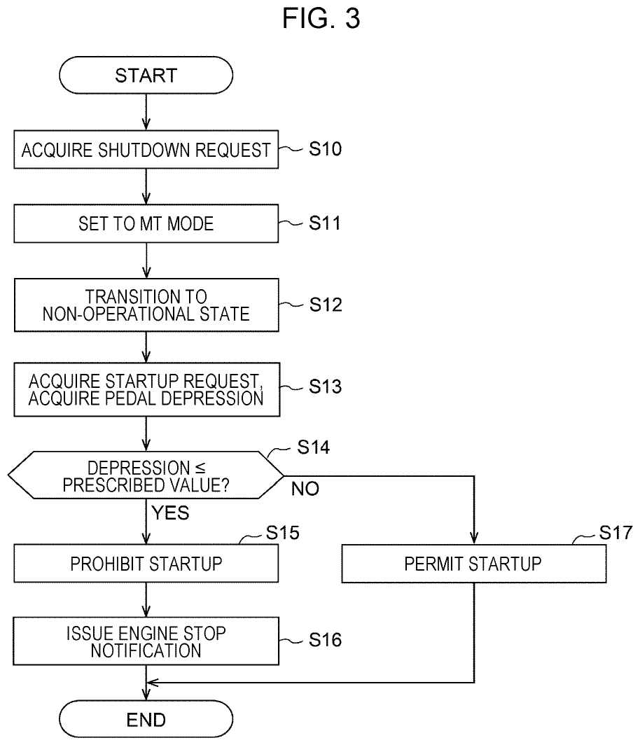

The following refers to FIG. 3 to describe a first example of operations by the jackrabbit start suppression device 30 according to the present embodiment by following the flowchart.

In this example of operations, the vehicle 1 is assumed to be traveling in either of the travel modes, that is, AT mode or MT mode.

In step S10, the acquisition unit 33 acquires a vehicle 1 shutdown request from the driver. Specifically, the acquisition unit 33 acquires via the vehicle control device 11 a control signal indicating that the start switch has been switched off by the driver. Note that in step S10, it is assumed that the vehicle 1 has come to a stop in either of the travel modes, that is, AT mode or MT mode and is in the operational state. After that, the process proceeds to step S11.

In step S11, the mode setting unit 34 sets the travel mode at next startup of the vehicle 1 to MT mode. After that, the process proceeds to step S12.

In step S12, the startup control unit 35 causes the vehicle 1 to transition from the operational state to the non-operational state. This causes the vehicle 1 to be powered off while the travel mode at next startup of the vehicle 1 is kept set to MT mode. Note that when the vehicle 1 is powered off in AT mode, the shift position of the simulated shift lever 19 may stay at “N”. After that, the process proceeds to step S13.

The following describes operations at next startup.

In step S13, the acquisition unit 33 acquires a vehicle 1 startup request from the driver and acquires the depression of the simulated clutch pedal 18 by the driver. Specifically, the acquisition unit 33 acquires via the vehicle control device 11 a control signal indicating that the start switch has been switched on by the driver. At or around the same time, the acquisition unit 33 acquires the depression of the simulated clutch pedal 18 by the driver on the basis of a detection signal from the simulated clutch pedal sensor 22. After that, the process proceeds to step S14.

In step S14, the startup control unit 35 determines whether the depression of the simulated clutch pedal 18 acquired in step S13 is less than or equal to a prescribed value. If it is determined that the depression of the simulated clutch pedal 18 is less than or equal to the prescribed value (step S14: YES), the process proceeds to step S15. On the other hand, if it is determined that the depression of the simulated clutch pedal 18 is not less than or equal to the prescribed value (that is, exceeds the prescribed value) (step S14: NO), the process proceeds to step S17.

In step S15, the startup control unit 35 prohibits startup of the vehicle 1. This causes the vehicle 1 to stay in the non-operational state (Ready OFF) even if there is a startup request from the driver in step S13. At this time, an engine stall condition of the vehicle 1 may be reproduced in a simulated manner by the travel control unit 36. After that, the process proceeds to step S16.

In step S16, the notification processing unit 37 controls the driving of the notification device 12 to notify the driver that the vehicle 1 was not started up properly. The notification processing unit 37 issues the notification, for example, by outputting sound or speech, or by presenting an image display or a text display. The notification may include a notification indicating that the vehicle 1 has entered an engine stall condition, but the present disclosure is not limited thereto. After that, the process ends.

Note that if there is another startup request from the driver after step S16, the startup control unit 35 may permit startup of the vehicle 1.

On the other hand, in the case where the processes proceeds from step S14 to step S17, in step S17 the startup control unit 35 permits startup of the vehicle 1. This causes the vehicle 1 to transition from the non-operational state (Ready OFF) to the operational state (Ready ON) and be ready for travel in MT mode under control by the travel control unit 36.

In other words, the vehicle 1 travels in MT mode until the driver operates the toggle switch for switching between MT mode and AT mode. While the vehicle 1 being in MT mode, the position lamp of the shift switch 25 is turned off and the shift switch 25 is also rendered inoperable.

If the vehicle 1 stops while in MT mode and the toggle switch is operated by the driver, the travel mode transitions from MT mode to AT mode. At this time, the simulated shift lever 19 may be moved and locked at the “N” position automatically, and the shift switch 25 may be set to the “P” position automatically. Also, if the toggle switch is operated by the driver while the vehicle 1 is traveling in MT mode, the travel mode transitions from MT mode to AT mode. At this time, the simulated shift lever 19 may be moved and locked at the “N” position automatically, and the shift switch 25 may be set to the “D” position automatically. Note that the vehicle 1 may travel in AT mode until the next time the toggle switch is operated, and while the vehicle 1 being in AT mode, the simulated shift lever 19 may be inoperable or stowed internally in the vehicle.

On the other hand, if the vehicle 1 stops while in AT mode and the toggle switch is operated by the driver, the travel mode transitions from AT mode to MT mode. At this time, the simulated shift lever 19 stays at the “N” position, and the lamp of the shift switch 25 is turned off. Also, if the toggle switch is operated by the driver while the vehicle 1 is traveling in AT mode, the travel mode transitions from AT mode to MT mode. At this time, the simulated shift lever 19 stays at the “N” position, and the lamp of the shift switch 25 is turned off. Instead, however, if the toggle switch is operated while the vehicle 1 is traveling, a notification such as “Please switch modes while the vehicle is stopped” may be issued to the driver by the notification device 12.

### 2-4. Second Example of Operations by Jackrabbit Start Suppression Device

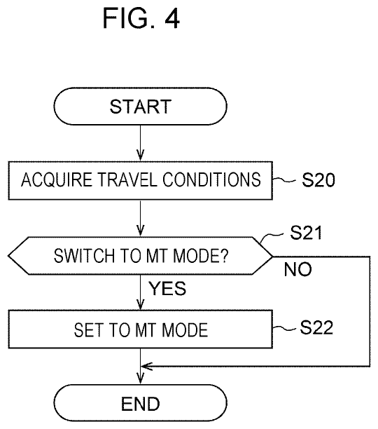

The following refers to FIG. 4 to describe a second example of operations by the jackrabbit start suppression device 30 according to the present embodiment by following the flowchart. Note that the second example of operations is executed after step S16 or step S17 in the first example of operations.

In this example of operations, the acquisition unit 33 additionally acquires information indicating travel conditions of the vehicle 1. Specifically, the information indicating travel conditions includes one or more of the following information: (i) information indicating conditions in which the vehicle is parked in a parking lot; (ii) information indicating conditions in which the vehicle is stuck in traffic; and (iii) information indicating conditions in which the vehicle is waiting at a traffic signal.

Also, in this example of operations, if AT mode is set, the mode setting unit 34 executes a process to switch the travel mode at starting of the vehicle 1 from AT mode to MT mode on the basis of the information indicating travel conditions acquired by the acquisition unit 33.

The following assumes that the vehicle 1 is traveling in AT mode.

In step S20, the acquisition unit 33 acquires information indicating travel conditions of the vehicle 1. Specifically, the acquisition unit 33 performs known or chosen image processing on image data from the surrounding environment sensor 13 to acquire information pertaining to any of the following: (i) conditions in which the vehicle is parked in a parking lot; (ii) conditions in which the vehicle is stuck in traffic; and (iii) conditions in which the vehicle is waiting at a traffic signal. At this time, machine learning such as a deep neural network (DNN) may be used. However, the information indicating travel conditions may be acquired not from the surrounding environment sensor 13 but instead on the basis of, for example, vehicle 1 position information from the GNSS sensor 15 and map information stored in advance in the storage unit 32. After that, the process proceeds to step S21.

In step S21, the mode setting unit 34 determines whether to switch the travel mode at starting of the vehicle 1 from AT mode to MT mode, on the basis of the travel conditions of the vehicle 1 acquired in step S20. Specifically, the mode setting unit 34 may determine to switch the travel mode at starting of the vehicle 1 from AT mode to MT mode in (i) conditions in which the vehicle 1 is parked in a parking lot and (ii) conditions in which the vehicle is stuck in traffic. On the other hand, the mode setting unit 34 may determine not to switch the travel mode at starting of the vehicle 1 from AT mode to MT mode (that is, stay in AT mode) in (iii) conditions in which the vehicle is waiting at a traffic signal.

If it is determined to switch from AT mode to MT mode (step S21: YES), the process proceeds to step S22. On the other hand, if it is not determined to switch from AT mode to MT mode (step S21: NO), the process ends. In other words, the travel mode of the vehicle 1 stays in AT mode. This can prevent annoyance caused by the travel mode being changed from AT mode to MT mode every time the vehicle waits at a traffic signal.

In step S22, the mode setting unit 34 switches the travel mode of the vehicle 1 from AT mode to MT mode. This causes the vehicle 1 to travel in MT mode under control by the travel control unit 36. In other words, when starting the vehicle 1, the driver is to put the shift position of the simulated shift lever 19 in first gear, and accelerate the vehicle 1 by depressing the accelerator pedal 16 while letting off the simulated clutch pedal 18, in a manner similar to a normal MT vehicle. Consequently, this can prevent jackrabbit starts in a parking lot and jackrabbit starts while the vehicle is in traffic, for example. After that, the process ends.

Note that in step S22, if the travel mode is switched from AT mode to MT mode, the notification processing unit 37 may control the driving of the notification device 12 to notify the driver that the travel mode has been switched.

As a modification of step S20 and step S21 described above, when AT mode is set, the mode setting unit 34 may calculate the duration of the travel conditions on the basis of the information indicating travel conditions, and switch the travel mode at starting of the vehicle 1 from AT mode to MT mode on the basis of the calculated duration.

Specifically, in step S20 and step S21 described above, the acquisition unit 33 acquires the vehicle speed of the vehicle 1 as an example of the information indicating travel conditions, the vehicle speed being acquired via the vehicle state sensor 14 instead of the surrounding environment sensor 13. If the vehicle speed of the vehicle 1 stays at or below a prescribed speed for a duration equal to or greater than a prescribed time, for example, the mode setting unit 34 may determine to switch the travel mode at starting of the vehicle 1 from AT mode to MT mode, for example. On the other hand, if the vehicle speed of the vehicle 1 stays at or below the prescribed speed for a duration less than the prescribed time, the mode setting unit 34 may determine not to switch the travel mode at starting of the vehicle 1 from AT mode to MT mode.

Note that the prescribed speed may be a speed within the range from 0 km/h to 10 km/h, for example, but the present disclosure is not limited thereto, and the prescribed speed can be set as appropriate. The prescribed speed may be set to allow for distinguishing between conditions in which the vehicle 1 is stuck in traffic and conditions in which the vehicle 1 is waiting at a traffic signal, for example. The prescribed time may be a time ranging from dozens of seconds to several minutes, for example, but the present disclosure is not limited thereto, and the prescribed time can be set as appropriate. The prescribed time may be set to allow for distinguishing between conditions in which the vehicle 1 is stuck in traffic and conditions in which the vehicle 1 is waiting at a traffic signal, for example.

### 3. Effects

As described above, the jackrabbit start suppression device 30 as in the present embodiment is a device for suppressing jackrabbit starts of the vehicle 1 provided with drive motor 2, the accelerator pedal 16 configured to accept an acceleration demand by the driver, the simulated clutch pedal 18 configured to be operated by the driver and to simulate clutch operations, and the simulated shift lever 19 configured to be operated by the driver and to simulate gearshift operations. The processing unit 31 of the jackrabbit start suppression device 30 sets the travel mode at next startup of the vehicle 1 to MT mode, regardless of whether the last startup of the vehicle 1 was stopped while the vehicle 1 being in MT mode, in which gearshift operations and clutch operations are enabled, or in AT mode, in which gearshift operations and clutch operations are disabled. The processing unit 31 of the jackrabbit start suppression device 30 prohibits startup of the vehicle 1 if the driver performs the vehicle 1 startup operation while the depression of the simulated clutch pedal 18 is less than or equal to the prescribed value.

According to such a configuration, even if the previous travel (trip) ends while the vehicle 1 being in AT mode, the travel mode at next startup of the vehicle 1 is always set to MT mode. This means that at next startup of the vehicle 1, the driver is to depress the simulated clutch pedal 18, and then accelerate the vehicle 1 while letting off the simulated clutch pedal 18. Consequently, since the driver is more aware that vehicle 1 is an MT vehicle, the driver starts the vehicle 1 more cautiously than with an AT vehicle, thus suppressing a jackrabbit start caused by a misstep that does not conform to driver intentions, which occurs more readily in an AT vehicle. In other words, it is possible to suppress jackrabbit starts that do not conform to driver intentions in an electric vehicle in which driver operations for a vehicle provided with a manual transmission are reproduced in a simulated manner.

Also, according to the jackrabbit start suppression device 30 as in the present embodiment, the following effects are also exhibited. For example, in AT vehicles, there is known technology that permits or prohibits travel of the vehicle 1 on the basis of the operated state of a jackrabbit start prevention pedal that is different from the accelerator and brake pedals. With this technology, the driver is not required to depress the jackrabbit start prevention pedal when starting the engine, and thus the driver still thinks of the vehicle as an AT vehicle. This means that a driver who is accustomed to operating an AT vehicle may attempt to start the vehicle by first depressing the accelerator pedal after engine start. However, the vehicle does not start in such a case, and the driver is burdened with remembering that the vehicle will not start unless the jackrabbit start prevention pedal is depressed, and then depressing the jackrabbit start prevention pedal again. In contrast, according to the jackrabbit start suppression device 30 as in the present embodiment, the driver thinks of the vehicle as an MT vehicle, and when starting the vehicle 1, the driver is to depress the simulated clutch pedal 18, and then accelerate the vehicle 1 while letting off the simulated clutch pedal 18, which may also prevent the burden of depressing the pedal again as described above.

The above describes a preferred embodiment of the present disclosure in detail and with reference to the accompanying drawings, but the present disclosure is not limited to such an example. It is clear that a person with ordinary knowledge in the field of technology to which the present disclosure belongs could conceive of various modifications or alterations within the scope of the technical concepts recited in the claims, and any such modifications or alterations are naturally understood to also be within the technical scope of the present disclosure. For example, the functions and the like included in the components, steps, or the like can be rearranged in logically non-contradictory ways. Multiple components, steps, or the like can be combined into one, or alternatively, a component, step, or the like may be subdivided.

Besides the vehicle 1 described above, the technology of the present disclosure is also applicable to a vehicle provided with a known or chosen transmission mechanism that is electrically controllable.

Moreover, the technology of the present disclosure can also be achieved as the vehicle 1 provided with the jackrabbit start suppression device 30 set forth in the embodiment described above, as a jackrabbit start suppression method to be executed by the jackrabbit start suppression device 30, as a computer program causing a computer to function as the jackrabbit start suppression device 30 described above, or as a non-transitory tangible recording medium storing the computer program.

According to an embodiment of the present disclosure, it is possible to suppress jackrabbit starts that do not conform to driver intentions in an electric vehicle in which driver operations for a vehicle provided with a manual transmission are reproduced in a simulated manner.

The processing unit 31 illustrated in FIG. 2 can be implemented by circuitry including at least one semiconductor integrated circuit such as at least one processor (e.g., a central processing unit (CPU)), at least one application specific integrated circuit (ASIC), and/or at least one field programmable gate array (FPGA). At least one processor can be configured, by reading instructions from at least one machine readable tangible medium, to perform all or a part of functions of the processing unit 31 including the acquisition unit 33, the mode setting unit 34, the startup control unit 35, the travel control unit 36, and the notification processing unit 37. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the non-volatile memory may include a ROM and a NVRAM. The ASIC is an integrated circuit (IC) customized to perform, and the FPGA is an integrated circuit designed to be configured after manufacturing in order to perform, all or a part of the functions of the modules illustrated in FIG. 2.

1. A jackrabbit start suppression device configured to suppress a jackrabbit start of a vehicle, the vehicle comprising with a drive motor, an accelerator pedal configured to accept an acceleration demand by a driver who drives a vehicle, a simulated clutch pedal configured to be operated by the driver and to simulate a clutch operation, and a simulated shift lever configured to be operated by the driver and to simulate a gearshift operation, the jackrabbit start suppression device comprising:
at least one processor and at least one memory communicatively connected to the at least one processor, wherein
the at least one processor is configured to
set a travel mode at next startup of the vehicle to an manual transmission mode, regardless of whether last startup of the vehicle was stopped while the vehicle being in the manual transmission mode, in which a gearshift operation and a clutch operation are enabled, or in an automatic transmission mode, in which the gearshift operation and the clutch operation are disabled, and
prohibit startup of the vehicle when the driver performs a startup operation of the vehicle while a depression of the simulated clutch pedal is less than or equal to a prescribed value.

2. The jackrabbit start suppression device according to claim 1, wherein
the at least one processor is configured to
acquire information indicating travel conditions of the vehicle, and
when the automatic transmission mode is set, switch the travel mode at starting of the vehicle from the automatic transmission mode to the manual transmission mode, based on the acquired information indicating the travel conditions.

3. The jackrabbit start suppression device according to claim 2, wherein
the at least one processor is configured to
when the automatic transmission mode is set, calculate a duration of the travel conditions, based on the acquired information indicating the travel conditions, and
switch the travel mode at the starting of the vehicle from the automatic transmission mode to the manual transmission mode, based on the calculated duration.

4. The jackrabbit start suppression device according to claim 2, wherein
the information indicating travel conditions comprises one or more pieces of information below:
information indicating conditions in which the vehicle is parked in a parking lot;
information indicating conditions in which the vehicle is stuck in traffic; and
information indicating conditions in which the vehicle is waiting at a traffic signal.

5. The jackrabbit start suppression device according to claim 3, wherein
the information indicating travel conditions comprises one or more pieces of information below:
information indicating conditions in which the vehicle is parked in a parking lot;
information indicating conditions in which the vehicle is stuck in traffic; and
information indicating conditions in which the vehicle is waiting at a traffic signal.

6. A vehicle comprising:
a drive motor;
an accelerator pedal configured to accept an acceleration demand by a driver who drives a vehicle;
a simulated clutch pedal configured to be operated by the driver and to simulate a clutch operation;
a simulated shift lever configured to be operated by the driver and to simulate a gearshift operation; and
the jackrabbit start suppression device according to claim 1.

7. A vehicle comprising:
a drive motor;
an accelerator pedal configured to accept an acceleration demand by a driver who drives a vehicle;
a simulated clutch pedal configured to be operated by the driver and to simulate a clutch operation;
a simulated shift lever configured to be operated by the driver and to simulate a gearshift operation; and
the jackrabbit start suppression device according to claim 2.

8. A vehicle comprising:
a drive motor;
an accelerator pedal configured to accept an acceleration demand by a driver who drives a vehicle;
a simulated clutch pedal configured to be operated by the driver and to simulate a clutch operation;
a simulated shift lever configured to be operated by the driver and to simulate a gearshift operation; and
the jackrabbit start suppression device according to claim 3.

9. A vehicle comprising:
a drive motor;
an accelerator pedal configured to accept an acceleration demand by a driver who drives a vehicle;
a simulated clutch pedal configured to be operated by the driver and to simulate a clutch operation;
a simulated shift lever configured to be operated by the driver and to simulate a gearshift operation; and
the jackrabbit start suppression device according to claim 4.

10. A vehicle comprising:
a drive motor;
an accelerator pedal configured to accept an acceleration demand by a driver who drives a vehicle;
a simulated clutch pedal configured to be operated by the driver and to simulate a clutch operation;
a simulated shift lever configured to be operated by the driver and to simulate a gearshift operation; and
the jackrabbit start suppression device according to claim 5.
